(19) United States
(12) Patent Application Publication
(10) Pub. No.: US 2022/0318940 A1
(43) Pub. Date: Oct. 6, 2022

(54) SYSTEM AND METHOD FOR CUSTOMIZED ESTATE ADMINISTRATION ASSISTANCE

(71) Applicant: Cadence Final Document Services Ltd., Saskatoon (CA)

(72) Inventors: Rachel Drew, Saskatoon (CA); Rachelle Perron, Saskatoon (CA)

(21) Appl. No.: 17/411,680

(22) Filed: Aug. 25, 2021

(30) Foreign Application Priority Data
Mar. 30, 2021 (CA) 3113486

(51) Int. Cl. G06Q 50/18; G06F 16/25; G06F 16/23; G06F 16/2457

(52) U.S. Cl. CPC G06Q 50/186; G06F 16/252; G06F 16/235; G06F 16/2457

(57) ABSTRACT

A system and method for provision of self-service assistance in documentary estate administration tasks. Through the conduct of an electronic interview in which jurisdictional and nonjurisdictional filter values in respect of a decedent are captured, estate administration software component can filter and provide jurisdictionally relevant forms for use in the administration of the estate of the decedent.

### TECHNICAL FIELD

This invention is in the field of business information systems used in the planning and management of estate administration on behalf of decedents, and more specifically comprises a system for customized self-service estate administration assistance.

### BACKGROUND

Many industries have benefited from significant speed and quality enhancements and business processes from the deployment of software-based systems and certain business functions. These systems allow for significantly improved outcomes and optimized workflows across virtually any aspect of a business or personal activity.

One of the areas in which families and individuals invest a great deal of time and effort is related to estate planning and estate administration in anticipation of or upon the death of a loved one. There is a great deal of information which needs to be updated, forms filed and the like upon the death of an individual, either with or without the assistance of a professional estate executor, and if it were possible to provide enhanced tools for use in this function it is believed that many individuals would benefit. Both in a preplanning context as well as post death, the provision of streamlined electronic record-keeping and informational update functionality of this nature would it is believed simplify processes for estate administration and planning while also easing the burden upon loved ones after the death of an individual.

Many of the tasks which loved ones would find themselves responsible for carrying out following the death of a loved one would comprise simple information update tasks—updating mailing information, cancelling subscriptions, updating government address records and the like. Any number of these types of tasks are not something that would typically be undertaken by professional estate administration help or if they were they would be undertaken at a significant cost to the individual. If it were possible to simplify the handling of many of the simple informational tasks it is believed that this would be a commercially desirable system and approach.

One of the complicating factors to providing a systemized self-service approach to this type of basic information assistance to date has been that there is an extremely complicated decision matrix applicable to required information updates and filings of this nature. It is very difficult to determine the nature of the applicable rules and applicable forms, and so it is believed that it would be even further desirable if it was possible to systemize the actual selection of the necessary forms and information for completion and filing in addition to assisting users in doing so. Development of an information system which would the appropriate information and forms for completion and filing based upon the multiple available decision points will be understood to be extremely commercially desirable.

Primary decision-making data points in selecting the required or available forms and information to be completed or filed relate to one or more jurisdictional requirements or values with respect to the decedent or the planning individual. A system that permitted the selection of the necessary or required forms and information fields based upon an appropriate ranked determination of applicable jurisdictional values i.e. individual jurisdiction, corporate jurisdiction where taxes were paid or filed etc., would also be desirable.

Completion of all of these informational requirements is a significant requirement upon death of a loved one and it is believed that the provision of a business system of this nature would significantly reduce friction for the loved ones and estate administrators handling these various tasks. Also, providing a system that would streamline this process would reduce cost to the estate and hopefully would also reduce total time requirements or increase the velocity to the completion of the administration of the estate to again provide some additional emotional comfort to the loved ones and family of the decedent. The overarching concept of the present invention is to provide a self-service business system which could be used to assist in the identification and completion of necessary informational requirements in respect of a decedent and the administration of an estate with the greatest efficiency and speed as possible, and being capable of identifying the applicable informational requirements based upon various data values with respect to the decedent including jurisdictional and nonjurisdictional values. Such a system could also provide additional functionality in terms of the ability to generate referrals of estate administration individuals to professionals where professional assistance might be required etc. The add-on functionality which could be built upon the data and model outlined in the remainder of this application will be understood to those skilled in the art.

### SUMMARY

As outlined above and herein it is the overall intention of the present invention to provide a computer implemented method of providing self-serve assistance and estate administration tasks to individuals in respect of a decedent, that would simplify and reduce friction in postdeath informational filing and estate administration tasks.

The method of providing self-service assistance to a user in documentary estate administration tasks, as outlined throughout, relies upon a server comprising a processor and memory, along with a network interface for the communication of the server with user client devices each having a user interface. The server also hosts a estate administration software component for executing the steps of the method.

The server would host or be operatively connected to a form database which contains form records which each correspond to a form for completion in respect of a decedent. Each form record would comprise at least a jurisdictional filter value corresponding to the decedent's residential jurisdiction respect of which the forms to be used, which is selected from a list of standardized jurisdictional values. Use of a finite standardized jurisdictional value list with respect to the jurisdictional filter values results in the ability to standardize the selection and availability of certain forms. In addition to a jurisdictional filter value, the form record might also comprise nonjurisdictional filter values corresponding to other decedent data which further limit the applicability of the corresponding form to a particular decedent.

In addition to jurisdictional and nonjurisdictional filter values, the form records would each include rendering data for the rendering of the form in question for display or download from the server to a client device. In addition to the necessary information to render the form, the form record would also include any field indicators which were required, which mapped any additional decedent data inputs required from a user or calculations that were required in order to render the form. Overall each form record would contain the necessary information to properly filter the display or availability of the related form based upon jurisdictional and nonjurisdictional filter values corresponding to the decedent, along with any other additional decedent data inputs or field indicators required to be captured in a user interviewed by the user interface of the client device to be used in the rendering of the form for display or download.

In addition to the forms database, the server would also host or be operatively connected to a decedent database which comprised decedent records each corresponding to a decedent in respect of whom the system would be used to assist in estate administration. Each decedent record would comprise at least information corresponding to the identification of the decedent along with the residential jurisdiction of the decedent selected from the list of standardized jurisdictional values. The decedent record could also include additional decedent data values corresponding to the decedent and their estate.

Based upon the server, the estate administration software component and the related datasets connected thereto, the method would comprise creating decedent records in the decedent database in respect of individual decedents is required, in a interview step. This would comprise, using the server and the estate administration software component, initiation of a communication session with a user client device via which a user could complete a user interview. The software on the server, in communication with the user client device would conduct a user interview in which the user can enter decedent data by the server serving a data entry interface to the user interface of the user client device, which can be interacted with by the user and information captured and transmitted back from the user client device to the server. Captured decedent data from the interview would correspond to at least the identification of the decedent, the residential jurisdiction of the decedent selected from the list of standardized jurisdictional values, along with any additional decedent data values corresponding to the decedent and their estate.

The user client device would facilitate the transmission of the captured decedent data to the server, and upon receipt of that transmission of the server, the server and the software component would facilitate the creation and storage of the decedent record in the decedent database which stored the captured decedent data. In certain embodiments of the system and method of the present invention the decedent record might be captured, created and stored for return use by the user i.e. the system could provide a login method in respect of which the created decedent record could be stored and associated, so that the user could return at later dates to either modify the decedent record by adding more information or to generate additional forms. In other embodiments of the system and method of the present invention the decedent record at the decedent database might be a nonpermanent data array or memory structure, by which the captured decedent data and related decedent record information would only be stored for long enough to complete the user session in which forms could be rendered and the like. Both such approaches are contemplated within the scope of the present invention.

In addition to administration of the decedent database, the method of the present invention would also is requested or required provided estate administration assistance to a user client device in respect of a request decedent. Where a user client device requested the initiation of an estate administration session in which forms could be rendered, the user client device working in conjunction with the software component on the server could conduct a matching step which would comprise capturing identifying information of the requested decedent from the user client device and matching the identifying information of the requested decedent captured from the user client device to a decedent record in the decedent database. This decedent record is the selected decedent record. Following the identification of a selected decedent record, the matching step would continue in execution by the software component on the server, wherein the software component would scan the form records stored within the form database to identify any matched form records. Matched form records would be those for which the residential jurisdiction stored in the selected decedent record matches the traditional filter value stored in the form record, along with any nonjurisdictional filter values stored in the form record being matched to decedent data values in the selected decedent record.

Assuming that at least one form record matches the application of the residential jurisdiction and nonjurisdictional filter criteria, the server in the software component will facilitate the presentation of the details of matched form records to the user interface of the user client device from which the user can indicate a rendering selection for the matched form records which are selected form records.

The next step in the conduct of the rendering session would be a form rendering step which would comprise, for each selected form record, using the rendering data field indicators stored in the selected form record along with the decedent data stored in the selected decedent record to render a completed version of the form adapted to the decedent data stored in the selected decedent record, and displaying the completed version of the form to the user for use by the user interface of the user device. The only forms which would be made available for rendering or completion would be forms that were applicable based upon the residential jurisdiction and any other nonjurisdictional filter values of a particular decedent. Execution of the method will provide an ability for quick and straightforward identification of applicable forms for completion and filing, and rendering of same based upon information stored in a decedent record in respect of the decedent.

As outlined elsewhere and throughout, the system and method of the present invention can be used in respect of a decedent who is deceased and in respect of whom a decedent record has been created. Other embodiments of the system and method of the present invention would be capable of use in estate preplanning where the decedent in respect of whom a decedent record is created is a living individual. Both such approaches are contemplated within the scope of the present invention.

Various types of document assembly and form rendering terminology and methodology will be understood to be within the scope of the present invention including that the completed version of a form rendered in accordance with the execution of a rendering session in accordance with the method of the present invention might be adapted during the rendering thereof to include or exclude sections that are based upon the contents of the selected decedent record. Conditional document assembly, including or excluding sections from a document based upon the contents of data fields used in the document assembly process, will be understood to those skilled in the art and is contemplated within the scope of the present invention.

In addition to the residential jurisdictional filter value stored with respect to each decedent record, the nonjurisdictional filter values which are used to limit the selection of forms in respect of a particular decedent be selected from a virtually limitless number of types and categories of information, including but not limited to age, income, date of death, jurisdiction of birth, date of birth, residential address, cause of death, family status, marital status, vendor account number or status, government program registration or eligibility, or vendor subscription status. Any type of a nonjurisdictional filter value which can be stored in a decedent record for use as a value for use in determining the applicability or availability of a particular form in respect of a particular decedent, or which could also be used in calculations or form rendering, will all be understood to be within the scope of the present invention.

In more elaborate embodiments of the form rendering system of the present invention, at least one field indicator in a form record in the form database could include details of calculations to be used to determine a calculated value based upon decedent data in the selected decedent record—wherein the rendering of a related form when the form record was a matched form record would include executing the necessary calculation to render and display the calculated value in the rendered form. Again the use of form-based calculations in form rendering and document assembly applications will be understood to those skilled in the art and any type of calculations, be they numerical, date based or otherwise are all contemplated within the scope of the present invention.

The software component of the present invention could be programmed to facilitate the conduct of an adaptive user interview in the interview step, whereby the nature of the questions asked that the decedent data captured from the user was adapted based upon values entered by the user, to alter the questions presented and asked and the decedent data captured. For example, based upon a particular answer provided to a particular interview question that may prompt the availability or nonavailability of additional banks of questions in the interview to capture additional decedent data. Adaptation of the user interview in this fashion, by the server and the software component in conjunction with the user interface of the user client device, will be understood to be within the scope of the present invention as well.

Certain embodiments of the system and method of the present invention would also comprise the ability to facilitate the automatic filing of information updates with one or more authority requiring the filing of information updates upon the death of a decedent. In such a case the server would also comprise an authority database which contains at least one authority record corresponding to a network connected authority system that require data updates on death of a decedent. Each authority record would comprise at least any necessary authentication information to enable communication between the server and the authority system by the network connection. Such embodiments would also comprise a requirements database operatively connected to or hosted by the server which contained at least one requirement record which corresponded to a form or decedent data to be filed with an authority system in respect of a decedent rate each requirement record would comprise at least a link to the authority record of the corresponding authority requiring such a filing, a jurisdictional filter value corresponding to the decedent's residential jurisdiction in respect of which the requirement record is to be activated which is selected from the list of standardized jurisdictional values and any nonjurisdictional filter values corresponding to other decedent data which further limit the activation of the requirement record in respect of a particular decedent. Finally the requirement record would include the details of any required decedent data and format to be transmitted to the length authority system on activation of the requirement record. Effectively the system of the present invention in these embodiments could not only render forms for a user for use in various self-service estate administration informational tasks, but could also is customized and programmed using the requirement records automatically submit certain information to authorities requiring it i.e. the system could for example automatically filed certain decedent data by submission thereof to the authority system operated by a particular government, vendor etc. without the need for the user to even render and file a form.

In these modified embodiments and methods, the method being capable of automatic filing of information, the method would further comprise following the rendering step the execution of a requirement matching step. The requirement matching step would comprise scanning the requirement records stored within the requirements database to identify any matched requirement records, being any requirement records in which the residential jurisdiction stored in the selected decedent record matches the jurisdictional filter value stored in the requirement record, along with any nonjurisdictional filter value stored in the requirement record being matched to the decedent data values in the selected decedent record.

Where certain requirement records indicating the availability or desirability of automatic filing of certain information to one or more authorities existed and were selected, the details of the matched requirement records could be presented to the user interface of the user client device from which the user could indicate a transmission selection for the matched requirement records selected for rendering, being selected requirement records, and requirements transmission step could be executed in respect of each selected requirement record in which the required decedent data and format to be transmitted stored in the selected requirement record along with the decedent data stored in the selected decedent record, and the necessary authority system credentials stored in the related authority record, would be used for the estate administration software component of the server to initiate a communication session with the related network connected authority system and to transmit the required decedent data in the format to be transmitted to the authority system identified, on behalf of the user.

The present invention also encompasses the server and the estate administration software component outlined herein and as are used to execute the method of the present invention.

It is explicitly contemplated that the system and method of the present invention could be used not only for estate administration following the death of the decedent but could also be used as a estate administration planning tool, to permit for planning of estate administration tasks that might be required following the death of the decedent. Use of the system and method of the present invention for preplanning tasks, or effectively pre-populating a decedent record with information that could be used at a later date to assist in the self-service estate administration tasks contemplated by the remainder of the system and method, will be explicitly understood to those skilled in the art and are contemplated to be within the scope of the present invention.

### BRIEF DESCRIPTION OF THE DRAWINGS

To easily identify the discussion of any particular element or act, the most significant digit or digits in a reference number refer to the figure number in which that element is first introduced. The drawings enclosed are:

FIG. 1 is a schematic diagram of one embodiment of a system of the present invention including client devices for demonstrative purposes;

FIG. 2 is a block diagram demonstrating one embodiment of basic data structures of the databases of the system of FIG. 1;

FIG. 3 is a block diagram demonstrating the key components of one embodiment of the server in accordance with the present invention;

FIG. 4 comprises a flowchart demonstrating the steps of a first embodiment of the method of the present invention;

FIG. 4A is a flowchart demonstrating the steps of the first embodiment of a decedent record creation subroutine connected to the primary flowchart of FIG. 4;

FIG. 4B is a flowchart demonstrating the steps of the first embodiment of a form rendering subroutine connected to the primary flowchart of FIG. 4;

FIG. 5 is a schematic diagram of a second embodiment of a system of the present invention;

FIG. 6 is a block diagram demonstrating one embodiment of basic data structures of the databases of the system of FIG. 5;

FIG. 7 comprises a flowchart demonstrating the steps of a second embodiment of the method of the present invention; and

FIG. 7A is a flowchart demonstrating the steps of the first embodiment of an authority requirements transmission subroutine connected to the primary flowchart of FIG. 7.

### DETAILED DESCRIPTION

As outlined herein, the present invention comprises a system and method for use in the facilitation of self-service assistance in preplanning and estate administration tasks.

The primary group of estate administration tasks which it is intended to encompass with the system and method of the present invention are those which can be completed by family members or administrative support personnel following the death of a individual. In such a circumstance, the actual whale and estate of the decedent will likely be handled by a lawyer or estate executor to the point that those tasks are under control, but much of the work that is involved is more basic and informational in nature. Advising vendors of the death of a subscriber or customer, changing addresses or responsible individuals on insurance policies or other similar types of records, cancelling certain accounts etc.—these are all tasks which are quite often administered using forms and the filing of information updates with authorities or vendors and the like. Much of this work on an ongoing basis following the death of the decedent would often be carried out by a loved one or administration support and it is this particular grouping of tasks which it is desired to simplify with the system of the present invention by providing a system that would allow for the easy identification of which types of updates might need to be filed, and then to effectively help to complete them for filing.

The system of the present invention will comprise a form database containing necessary forms for filing with updates on information in respect of a decedent. One of the issues for the user however is to select the correct forms to be filed and particularly as the form database grows to make it more useful to more people, the list of available forms becomes unwieldy. One of the key aspects of the system of the present invention is providing a way to simplify the identification of relevant informational updates to be filed in such a self-serve method. It is necessary to provide a system function that will allow for filtering of the various forms to identify those that are relevant.

### Jurisdictional Filter Values

The primary filter value which is anticipated will be used to restrict the list of available forms from which a user can choose to restrict or reformulate the content and scope of the interview conducted in the interview step as well as to render the necessary forms is the jurisdiction of residence of the decedent. By requiring a user to select the jurisdiction of residence of the decedent, only forms and informational update options that apply in respect of the jurisdiction of residence of the decedent would be displayed as relevant and available in the remainder of the self-serve estate administration method.

It is specifically contemplated that the system would use a pre-populated selection list for the selection of a jurisdictional filter value i.e. there would be a predefined list of jurisdictions on the list and it would only be from those jurisdictions from which a user could select in specifying the jurisdictional filter value for use in respect of a particular decedent record. This would allow for the imposition of a somewhat rigid hierarchy on the forms in the form database from the perspective of selection of their applicability to a particular decedent although the level of granularity in that predefined list of jurisdictions could be finer or broader—it could be set up to permit selection of something as granular as a street address as the jurisdictional filter value, or in a broader context it could be set on a town or province level.

The jurisdictional filter value could also be used as a decedent data input for use in the assembly of forms in accordance with the remainder of the present invention.

### Non-Jurisdictional Filter Values

In addition to a residential jurisdictional filter value stored within the decedent records in the decedent database, which is used of the primary filtering element for the purpose of identifying applicable forms corresponding to form records in the form database, additional nonjurisdictional filter values can also be used in the method of the present invention and stored in a decedent record. Decedent data fields, which could be used both as nonjurisdictional filter values as well as values for storage and rendering into forms being completed in accordance with the remainder of the present invention could include virtually any type of information in relation to a decedent. Without limiting the generality of the foregoing, nonjurisdictional filter values and decedent data values which can be stored in a decedent record for the purpose of use as filter values for the availability of particular form records, as well as for field values and the rendering of forms, could include fields selected from the group of: age, income, date of death, jurisdiction of birth, date of birth, residential address, cause of death, family status, marital status, vendor account number or status, government program registration or eligibility, or vendor subscription status.

The nonjurisdictional filter inputs which are entered and stored with respect to an interview and/or a decedent record could allow for the further filtration or limitation of the list of forms available for generation in accordance with the self-serve method of the present invention. For example where the nonjurisdictional filter values include age or income, the age or income values could be used along with the residential jurisdiction of the decedent to further limit the forms available and presented for selection to a user.

The non-jurisdictional filter inputs could either be entered or held in free-form data fields with appropriate filter algorithms or coding put in place and the remainder of the system, or some or all of them could also include pick lists such as were outlined above with respect to the jurisdictional filter input value corresponding to the residential jurisdiction of the decedent. Both such approaches are contemplated within the scope of the present invention.

Nonjurisdictional filter values, as in the case of the jurisdictional filter value outlined above, could in addition to being used to limit the list of available forms also be used as decedent data inputs in the actual document assembly aspect of the system and method of the present invention.

Both the jurisdictional and nonjurisdictional filter values could also be used as calculation inputs in the actual assembly of various forms as well as to in certain embodiments of the method where the forms were dynamic allow for the adaptation of the actual format of the form. All such approaches are again contemplated within the scope of the present invention.

In elaborate systems in accordance with the present invention where vendor specific forms or authority specific forms were required or desired to be presented for potential assembly and forwarding, nonjurisdictional filter values might include the selection of one or more vendors or authorities on a list to whom the decedent was a subscriber or customer etc.

### Pre-Planning

As outlined throughout this explicitly contemplated that the system and method of the present invention could be used in both estate administration tasks following the death of the decedent as well as in estate preplanning. In the context of an estate preplanning embodiment or execution of the method, the decedent in respect of whom a decedent record is created could be a living individual. Use of the system and method of the present invention both estate administration and estate preplanning applications will be understood to those skilled in the art and all such embodiments are explicitly contemplated within the scope of the present invention.

### Service Bureau

It is specifically contemplated that the method and server of the present invention could be offered on behalf of a plurality of decedent's i.e. the number of decedent records would be more than one, resulting in the ability to offer a service bureau to multiple users and the ability for multiple users to handle estate administration tasks in respect of multiple decedents at the same time through the operation of a single server and overall method. Operation of a locally hosted embodiment of the system of the present invention for use by a single user with respect to multiple decedents, or the operation of a more widely available embodiment of the system of the present invention and the method offering the unattended self-service estate administration help of the system to multiple users each in respect of individual decedents are both contemplated within the scope of the present invention.

### System and Architecture Overview

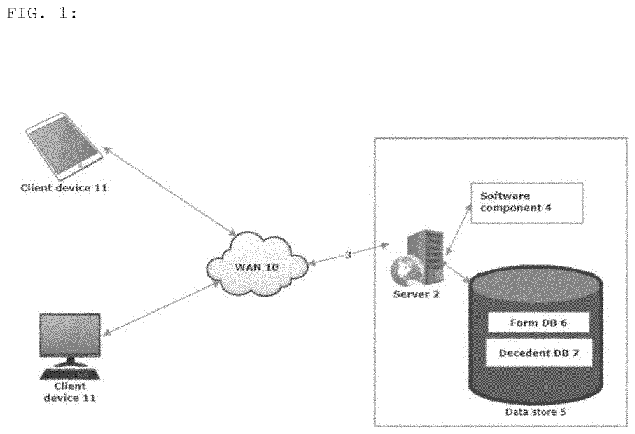

Referring to FIG. 1 there is shown sample embodiment of a server 2 in accordance with the present invention. The server 2 shown includes an estate administration software component 4 resident in the memory thereof for the purpose of execution of the method, along with the data store 5 which in the Figure as shown includes a form database 6 and a decedent database 7. The server 2 also by a network interface 3 is connected to a wide area network 10 such as the Internet. The server 2, via the network 10 would communicate with user client devices 11. The system of FIG. 1 shows two different user client devices 11, one of which is a mobile tablet device and the other of which as shown is a computer. It will be understood that really any type of a client device 11 capable of communicating with the server 2 via a network interface and facilitating interface based interaction between a user at the client device 11 and the server 2 within the context of the remainder of the invention will all be contemplated within the scope thereof.

A user, using a user client device 11, can initiate communication sessions with the server 2 via the network 10, in which decedent records can be created or updated in the decedent database 7, as well as executing form retrieval transactions in accordance with the remainder of the method whereby, based upon the contents of the decedent record in the decedent database 7 a user client device 11 can be used to initiate the jurisdictional and nonjurisdictional filtering of form records in the form database 6 to identify applicable forms in the case of a particular decedent and decedent record, and to then render those forms, completed with decedent specific information from the decedent record back to the screen or other user interface of the user client device 11. The server 2 and software component 4 in combination with the data structures and the remainder of the method will permit simplified self-service information completion and filing tasks in respect of decedent estates, through simplified electronic interface and in large part simplifying the retrieval and rendering of those forms by jurisdictionally filtering them down to only available forms that are applicable to a particular decedent record. Basically the system and method of the present invention will facilitate the automatic filtering and availability selection of only relevant forms from the form database 6 in respect of a particular decedent which will allow family members, state administrators or other individuals to expeditiously identify and complete forms need to be completed and filed in respect of a particular estate.

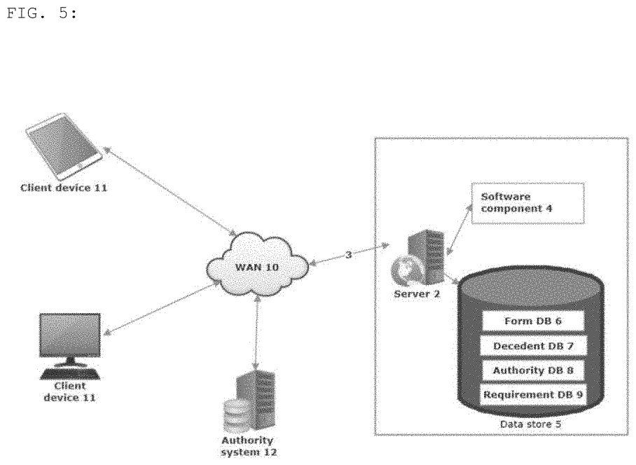

FIG. 5 shows an alternate system in accordance with the method of the present invention. The server embodiment and system overview shown in FIG. 5 is intended to outline what the architecture of a system would look like in accordance with the method of the present invention which included the ability for the server 2 in conjunction with the software 4 to facilitate the automatic transmission of data filing requirements with certain network connected authority systems 12. The server 2 as shown in this Figure is similar to the server of FIG. 1, except the data structures 5 is shown to include an authority database 8 and a requirement database 9 in addition to the form database 6 on the decedent database. In certain embodiments, the authority database 8 and the requirement database and will line could also be a single consolidated data structure of records which would achieve the same objective, wherein authority system credentials could be stored in individual requirement database records and a single record was only required to be used rather than to records from two separate tables for the purpose of executing a transmission. Both such approaches are contemplated within the scope of the present invention.

In addition to the user client devices 11 which can communicate with the server 2 by the network 10, an authority system 12 is also shown. The authority system could represent any type of a third-party computer system to which decedent data or rendered forms including decedent data from a decedent record in the decedent database 7 could be automatically transmitted for filing in the context of the method of the present invention. The authority system 12 which is shown is demonstratively shown as a server which would contain all the necessary hardware and software components to securely communicate with the server 2 and facilitate certain steps of the method of the present invention.

It is explicitly contemplated that authority systems 12 such as those shown typically provide an application programming interface (API) or some other type of network conductivity via which upon presentation of appropriate security credentials or authentication protocols, and outside server such as the server 2 can initiate a communication session with the authority system 12. As outlined in the remainder of the specification herein, it is contemplated that authority records in the authority database 8 would include the necessary authentication credentials for the initiation of transmission sessions with individual authority systems 12. Technical or architectural details of the authority system 12, beyond describing the general availability of the authority system 12 and the ability of the system 12 to initiate or participate in a communication session with the server 2 such as outlined for the purpose of receipt of a transmission at the authority system 12 of decedent data or forms rendered containing decedent data, from the server 2, will all be understood to be within the scope of the present invention.

### Server

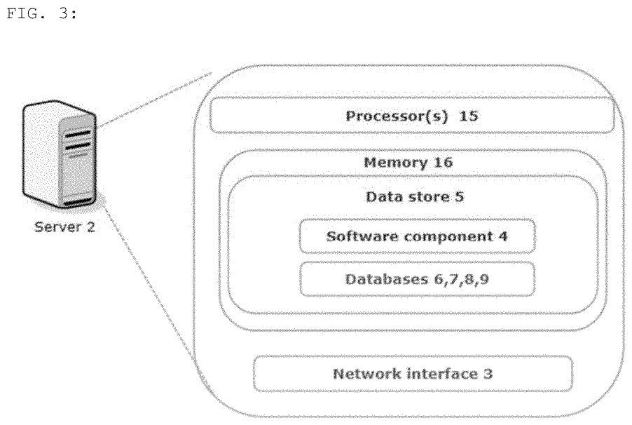

FIG. 3 shows one embodiment of a server 2 in accordance with the present invention. The method of the present invention and the overall architecture would be client/server in nature and would rely am server 2 configured for use in the self-serve estate administration method of the present invention. The server 2, a sample embodiment of which is shown in FIG. 3, might consist of one or more servers 2—a single server or a server farm approach. Each server 2 would comprise one or more processors 15 in memory 16. The memory 16 might contain various software components or a series of processor instructions for use in the method of the present invention or otherwise in the operation of the server 2. Processor instructions corresponding to the estate administration software component 4 are shown stored within the memory 16 in this Figure.

Memory 16 may comprise non-transitory storage media that electronically stores information. The electronic storage media of memory 16 may include one or both of system storage that is provided integrally (i.e., substantially non-removable) with server(s) 1 and/or removable storage that is removably connectable to server(s) 1 via, for example, a port (e.g., a USB port, a firewire port, etc.) or a drive (e.g., a disc drive, etc.). Memory 16 may include one or more of optically readable storage media (e.g., optical discs, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Memory 16 may include one or more virtual storage resources (e.g., cloud storage, a virtual private network, and/or other virtual storage resources). Memory 16 may store software algorithms, information determined by processor(s) 15, information received from server(s) 2, information received from client devices, and/or other information that enables server(s) 2 to function as described herein.

Processor(s) 15 may be configured to provide information processing capabilities in server(s) 2. As such, processor(s) 15 may include one or more of a digital processor, an analogue processor, a digital circuit designed to process information, an analogue circuit designed to process information, a state machine, and/or other mechanisms for electronically processing information. In some implementations, processor(s) 15 may include a plurality of processing units. These processing units may be physically located within the same device, or processor(s) 15 may represent processing functionality of a plurality of devices operating in coordination.

In many embodiments, the server 2 is contemplated to be a Web server, where client devices would use a web browser for interaction therewith. Where a local app was developed, server 2 might not be a Web server per se but might be a server 2 capable of interaction with that type of an interface on remote client devices. Either such approach is contemplated within the scope hereof.

Server 2 would also include at least one network interface 3 via which it could communicate with the at least one communications network for the purpose of enabling communication with the client devices and employee management systems of the remainder of the method as outlined herein. It will be understood by those skilled in the art of network design and hardware and software design that certain server architectures might include more than one network interface 3 and any type of a server 2 and network interface 3 design which enabled the communication of the server 2 as outlined in the remainder of the method would all be contemplated within the scope of the present invention.

### Estate Administration Software Component

The estate administration software component 4 resident on or accessible to the server 2 would be keyed to the performance of the present method. Functions of the estate administration software component 4 would include the creation, administration and maintenance of database records along with interacting with client devices of users as required for the purpose of facilitating the method. The estate administration software component 4 would also render forms from the form database and transmit those back as required to user client devices, and could also encompass any additional required querying, reporting or added software functionality.

The estate administration software component 4 will comprise any compiled processor instructions capable of being executed by the processor of the server 2 it will be understood that any estate administration software component 4 having the effect of being able to administer the method of the present invention as outlined is contemplated within the scope of the present invention.

### Form Database

The memory 16 of the server 2 will container be operatively connected to a plurality of data structures required for the operation of the system and method of the present invention. The first of these is a form database 6. The form database 6 is shown in FIG. 1 as a component of the data store 5. The data store 5 would be any type of the data structure storage array capable of storing the datasets required for the practice the method of the present invention including the form database 6.

The form database 6 comprises a plurality of form records 20, each of which corresponds to a form desired to be generated containing decedent data inputs and other information related to a decedent for transmission to the client device of the user or for the use of a user in satisfying various estate information management requirements in relation to a decedent using a self-service portal.

There are virtually limitless data structures which could be used for the form database 6 without departing from the intended scope and direction of the present invention outlined, but this Figure demonstrates one sample data structure of a form database 6 comprised of a plurality of form records 20 each of which contains the necessary data for the operation of the method of the present invention—specifically the necessary information to permit jurisdictional and nonjurisdictional filtering of the set of form records 20 down to a list of only a list of form records 20 of the corresponding forms which would be applicable in respect of a particular decedent for whom the system is being operated. The form record 20 would in most cases contain likely a record identifier 21 which is a serial key or other data structure or data token as understood to those skilled in the art database design. In addition to the form ID 21, the form record 20 would also include a jurisdictional filter value 22 which would be selected from a preset list of available jurisdictional values preprogrammed and stored elsewhere in the data store 5 or accessible to the server 2. In addition to the jurisdictional filter value 22 some or all of the form records 20 may include nonjurisdictional filters 23 which are additional fields or filter values against which decedent data values for a particular decedent can be compared to further filter the available list of forms and form records 20 to limit the available form records and 20 a particular user interface to those most applicable to a particular decedent scenario.

The jurisdictional filter value 22 and any nonjurisdictional filters 23 will permit the limiting and selection of form records 20 that are most applicable to a particular decedent by comparison of decedent jurisdiction and decedent data values thereto. In addition to the jurisdictional filter value 22 and the nonjurisdictional filter values 23 if entered, the form record would also include form rendering data 24. The form rendering data 24 would comprise any necessary code instructions, graphics or form rendering instructions which when executed by the processor's and the server 2 would result in the rendering of the desired finished form subject of the form record 20 for display or transmission etc. to a user client device. The form rendering data 24 may also comprise a form template with one or more fields contained therein which can be matched up to particular decedent data values and merged with those values for the purpose of displaying a completed form for use. Concept of form rendering, form templates at document assembly will be understood to those skilled in the art and is all contemplated within the scope of the present invention.

In addition to the form rendering data 24 form records 20 could also include field indicators 25, which could be any necessary additional mapping data required to map decedent data value fields from the decedent records 32 the rendering of a form corresponding to a form record 20. In other embodiments, the field indicators 25 could comprise a part of the form rendering data 24 or be built into a template of the form rendering data 24 comprise the template. The form record 20 would contain all the necessary information to allow for jurisdictional and/or nonjurisdictional filtering of the form record 20 as well as template or form rendering data 24 for the purpose of assembly of a form required in a particular circumstance in respect of a decedent, and populated with decedent data values or decedent data driven calculations.

As outlined, the form database 6 could take many different formats and structures including relational database, flat file system and the like. Any type of a data structure which was accessible to the estate administration software component 4 and could permit the facilitation of the method of the present invention by the software component 4 are all contemplated within the scope hereof.

### Decedent Database

In addition to the form database 6, the system of the present invention as demonstrated includes a decedent database 7 comprising a plurality of decedent records 30 each of which corresponds to a decedent and in respect of whom the system can assist in estate administration tasks. Each decedent record 30 comprises necessary record identifiers for database operation 31 along with identification particulars of the decedent 32. The identification particulars 32 of the decedent will be useful for the sake of data and user interfaces of the system of the present invention as well as for use as key decedent data values in the population of various forms in accordance with the remainder of the present invention.

The decedent record 30 would also include a decedent jurisdiction value 33. The decedent jurisdiction value 33 would be chosen from the same pre-populated limited list of available jurisdictional values as is used for the jurisdictional filter value 22 of the form records 20. By using the same picklist in respect of the selection of decedent jurisdiction values 33 and jurisdictional filter values 20 a direct concordance and a highly accurate filter can be built and used between those two fields and two sets of records. In addition to the decedent jurisdiction value 33 the decedent records 30 as shown in this Figure could also include additional decedent data values 34 captured in respect of the decedent. The decedent data values 34 as outlined could include any number of different types of information or data in respect of a decedent or their estate which might be required for the purpose of populating various forms in accordance with the remainder of the present invention. Decedent data values 34 could also be used in calculations to calculate values rendered into forms in accordance with a form stored in a form record 20.

It will be understood that one or more of the databases 6, 7, 8, 9 could also reside in a consolidated data structure in any number of different types of database designs or structures that achieve the objective of making these types of sets of data and information available for storage and recall in accordance with the remainder of the method of the present invention are all contemplated to be encompassed within the scope of the present invention.

### Authority Database

Other embodiments of the system and method of the present invention as outlined include the ability to not only jurisdictionally selected and complete forms in respect of the estate of the decedent but also to jurisdictionally and on jurisdictionally select particular data updates that need to be transmitted to one or more authorities requiring same. The transmission of data to authorities might include transmission of information to commercial systems, government authorities and the like based upon things as simple as date of death or the like through to more elaborate calculations rendered based upon decedent data values 34 captured in a decedent record 30.

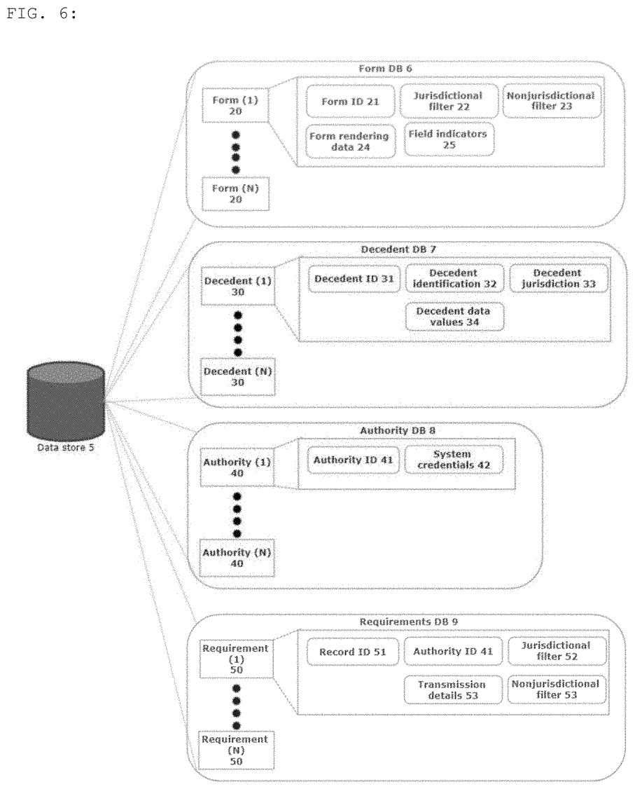

Embodiments of the method of the present invention include the ability to transmit jurisdictionally filtered and selected information to an authority system would also include an authority database 8 of some type in the data store 5 or elsewhere in the memory of the server 2. Referring to FIG. 6 there is shown an alternate data structure which includes the necessary additional data storage fields and records to facilitate the method of jurisdictionally filtered identification and transmission of selected data updates to authority systems on the death of a decedent. As shown, the authority database 8 comprises a plurality of authority records 40 each of which includes as shown a record identifiers 41 and storage of necessary credentials earth medication information 42 which could be used to enable the opening of communication sessions between the server 2 and an authority system 12 via the network connection of the server. The authority system comprises a network connected authority system requiring data updates on death of a decedent. Some government authorities might permit filing of death updates by manual filing of forms and the like, or may also provide a data interface such as the network connected authority system 12 which is shown and it is contemplated that certain embodiments of the system and method of the present invention could permit for either form-based preparation of filing material, or to allow a user by the user interface of their client device to select automatic submission of certain information or data updates to a network connected authority system and both such functions will be contemplated within the scope of the present invention and certain embodiments thereof. Authority records 40 could include additional information also required by the server 2, the software component 4 or otherwise in the system and method of the present invention to facilitate the method and any such modifications will be understood to those skilled in the art.

Similar to the form database 6 or the decedent database 7, the authority database 8 could also either be a database type data structure or could comprise and alternately stored set of processor instructions or the like on the system and both such approaches are contemplated within the scope hereof.

### Requirements Database

In conjunction with the authority database 8, the data structure of FIG. 6 shows a requirements database 9 which contains at least one requirement record 50 corresponding to a form or decedent data to be filed with an authority system in respect of the decedent. Each requirement record 50 would comprise at least, as shown, record identifier 51 along with a link to the corresponding authority record 41 of the corresponding network connected authority system to which the requirement in question requires a transmission of a form or a data update. Also shown is a jurisdictional filter value 52 which would again correspond to the preselected stored list of available jurisdictional filter values available on the server 2 or in accordance with the remainder of the method.

Also shown in the requirement record 50 of this Figure is a non-jurisdictional filter value 33. One or more nonjurisdictional filter values 53 could be stored for the purpose of further filtering or limiting the available requirement records 50 to be presented for potential selection and action by the user in accordance with the remainder of the self-serve method of the present invention.

As in the case of the form records 20 in the form database 6, the requirement records 50 in the requirement database 9 could be filtered using the jurisdictional filter and nonjurisdictional filter values 52, 53 against values stored within a decedent record 30.

Shown in the requirement record 50 is a field representing transmission details 54. The transmission details 54 would be any necessary data, templates, fields or other information required to facilitate the particular requirement transmission underlying the particular requirement record 50. For example if a particular requirement record 50 spoke to the need to transmit in a particular format a series of decedent data values 34 captured in a decedent record 30, the transmission details 53 could comprise the necessary template or other processor instructions to facilitate the server 2 via its network interface upon opening of an authority system communication session transmitting those decedent data values 34 in the required format. In cases where a transmission requirement represented by a requirement record 50 action required the transmission of a form containing decedent data values 34, the requirement record 50 could also be linked to a form record 20 containing the necessary form rendering data, or could contain for rendering data as the transmission details 54 both such approaches are contemplated within the scope of the present invention. Again the key to this aspect of the method of the present invention is that the operation of the estate administration software component 4 will permit the filtered limitation of requirement records 50 and form records 20 for presentation of only the jurisdictionally relevant records to a user of a client device connected to the server 2, optionally also further limited using nonjurisdictional filter criteria, and then permitting the self-serve fashion the user the client device to select from those filtered lists of matching form records 20 and requirement records 50 which of those records it is desired to action from the perspective of receiving the rendered or generated forms corresponding to the selected for records 20 and initiating any required transmissions and other software driven steps in respect of any filing requirements represented by the selected requirement records 50.

As in the case of the other databases and data structures outlined above, the requirement database 9 could also be of many different data structures or formats without departing from the intended scope hereof. Any type of a data structure, or even an in memory database storing this information which would allow the estate administration software component 4 to facilitate the remainder of the steps of the method of the present invention are all contemplated to be within the scope hereof.

### Method Overview

Having now described the majority of the system components required to execute the method of the present invention will now provide an overview of embodiments of methods of form submission and authority submission of information in respect of decedents in accordance with the self-service estate administration method of the present invention.

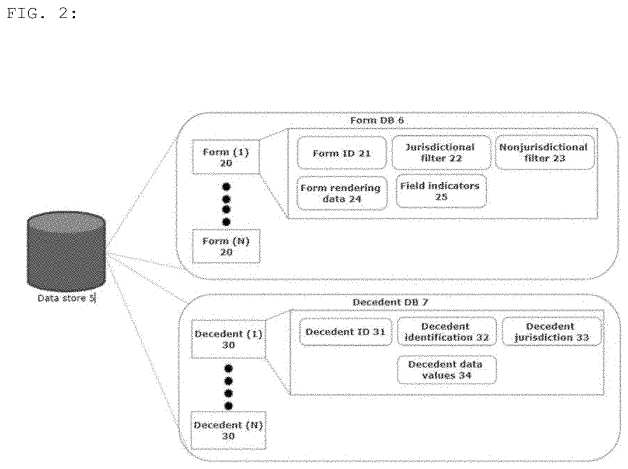

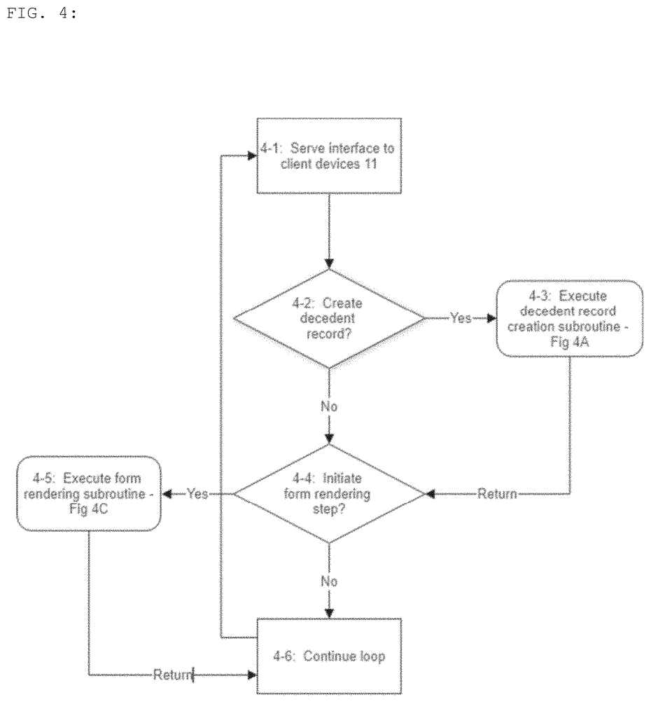

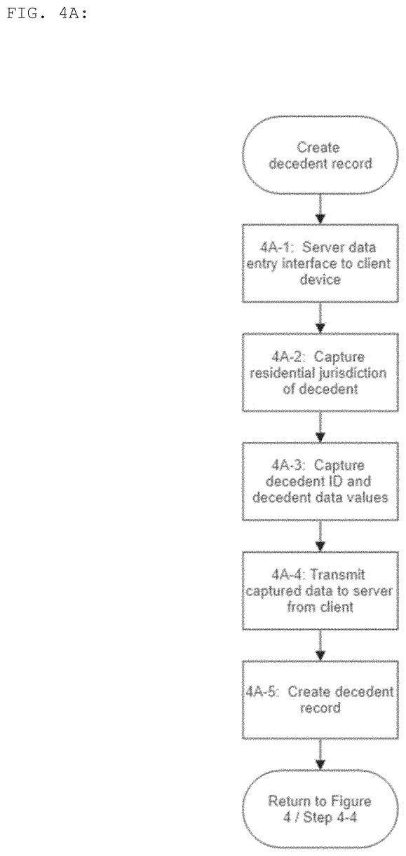

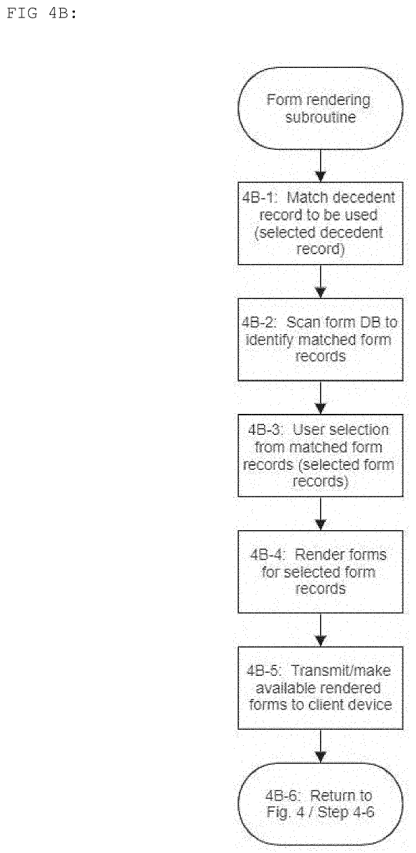

Referring first to FIG. 4 there is shown a flowchart demonstrating the steps of one embodiment of a method in accordance with the present invention. The method would be practised by a server and software configuration similar to that demonstrated in FIGS. 1 through 3 above.

It is explicitly contemplated that the server 2 would be a Web server presenting a portal interface to client devices 11 seeking indications there with by the network 10. Service of the ongoing user interface of the portal is shown at step 4-1.

The software component 4 and the remainder of the server and to the context of serving the portal will, as shown in the present embodiment, use a listener to detect a request from a client device 11 to initiate a session to create a decedent record 30 within a decedent database 7. Creation of a decedent record 30 would be the first user step to be taken by a user, via their client device 11, to engage with the system and to participate in the self-service estate administration assistance method of the present invention. The listener for initiation at this step is shown at step 4-2.

If the listener step 4-2 is triggered i.e. a user by their client device 11 initiates with the server 2 a request to create a decedent record, the execution of the decedent record creation subroutine of FIG. 4A is shown in step 4-3. In the decedent record creation subroutine demonstrated in one embodiment of FIG. 4A the first step would be for the server 22 survey data entry interface to the client device 11 initiating request—this would typically be a data entry form or triggering a multipage data entry interview in which the desired information could be entered and captured. Many different types of forms, interviews including those which are static or adaptive/dynamic in nature i.e. the client device 11 might always facilitate the entry of the same information, or in certain versions of the former the interview, the questions asked could be altered based upon other entries or information. Both such approaches are contemplated within the scope of the present invention.

In light of the residential jurisdiction filtering applied by the system and method of the present invention the first or most important data token captured in respect of a decedent in addition to their basic identification information is their residential jurisdiction, the capture of which is shown at step 4A-2. The residential jurisdiction filter value which would be entered in respect of the decedent for storage to the decedent record to be created would be selected from a standardized system-level list of jurisdictions.

In addition to the capture of the residential jurisdictional filter value in respect of the decedent, the Figure also shows the capture of other decedent identification information and other decedent data values at 4A-3. As will be understood from the remainder of the specification, decedent data values which are entered in respect of a particular decedent for storage to a decedent record might include basic information and informational values for use in the rendering of particular forms in respect of the decedent in question, and those fields might also be usable in parallel or in isolation as nonjurisdictional filter values to aid the software of the present invention in further limiting the selections of form records or requirement records in accordance with the remainder of the method.

Following the completion of the interview and/or the capture of various information in respect of a decedent for the creation of a decedent record, the captured decedent data and residential jurisdictional filter value will be transmitted to the server 2 from the client device, shown at 4A-4. On receipt of such a data transmission at the server, the software 4 would facilitate the creation of decedent record 30 in the decedent database 7 containing that information, shown at Step 4A-5. Control is then returned to the primary method of FIG. 4.

The specific order of capture of particular data entries or particular steps within routines or subroutines as outlined, insofar as they do not depart from the overall described intention and scope of operation of the method of the present invention, are all intended to be contemplated within the scope hereof.

Either following the return of control to this primary flow and Figure after the execution of the decedent record creation subroutine, or if the no leg of the Step 4-2 listener is followed, the method executed by the software component for the server 2 will next comprise another logic test shown at step 4-4, namely to detect whether or not the user client device 11 having initiated a immediately preceding decedent record creation, or another client device 11 having passed over the decedent record creation step, has requested the initiation of a form rendering step by the server 2. Effectively, if a user by their client device 11 wishes to execute the deliverable of assembled jurisdictionally filtered forms in accordance with the remainder of the present invention, the yes leg of this listener would be followed in the form rendering subroutine of FIG. 4B would be triggered as shown at step 4-5.

Referring to FIG. 4B, steps in a demonstrative example of an embodiment of a form rendering subroutine are shown. The server 2 and the software 4 would first in conjunction with information received from a client device 11 determine the selected decedent record 30 from the decedent database 7 which is necessary for the execution of this rendering subroutine. The rendering subroutine of this Figure might be conducted as a flow-through step immediately following the creation of a decedent record in accordance with the subroutine of FIG. 4 or in other embodiments of the method of the present invention, a user might return to the system via their client device 11 in communication with the server 2 to initiate a form rendering step or subroutine at some point in time following the creation of a decedent record 30. Either approach is contemplated within the scope of the present invention. Where the form rendering subroutine was committed immediately following the creation of the decedent record, necessary identifying information to match a decedent record, or the selected decedent record 30 itself might still be stored in the memory of the server 2 alternatively, matching the decedent record 30 to be used might entail at this step 4B-1 capturing identifying information and/or a security credential from the user device 11 in question to match the decedent record 30 in question and permits selection and use.

Following the determination of the selected decedent record 30, the next step in the subroutine shown at 4B-2 is the scanning of the form database 6 to identify any matched form records 20 which might in the initial cursory scan applied to the decedent in question. Matched form records 20 would be any form records 20 in which the jurisdictional filter value 22 stored in the form record 20 matched the jurisdictional filter value 33 stored in the selected decedent record 30. In certain cases the form record 20 in question might also include nonjurisdictional filter values 23 which would be compared against other decedent data values 34 stored within the selected decedent record 30. Following the application of the jurisdictional and nonjurisdictional filter values of the form records 20 in the form database 6 to the decedent data stored within the selected decedent record 30, a subset of form records 20, being matched form records, would be identified.

Following the completion of the selection of the matched form records 20, the next step in the subroutine shown would be the serving of a user selection interface to the client device 11 of the in which the details of the matched form records 20 would be displayed. For example it might be determined that there were five matching form records that met the filter criteria for a particular decedent and decedent record. The titles or other information of those five records could be presented in a selection menu to the user by their client device 11 such that they could select some or all of those forms to be rendered. Any forms that were selected to be rendered would comprise the selected form records. This user selection step is shown at step 4B-3.

The form rendering subroutine would then render all of the forms corresponding to the selected form records identified in step 4B-3. Form rendering is shown at step 4B-4. Finally, the rendered forms would be transmitted or otherwise made available to the client device and 11, shown at step 4B-5. Following the completion of this form rendering subroutine, control is passed back to the primary flow of FIG. 4 at step 4-6. The loop as shown would continue, with the server continuing to engage with the client devices of users to continue to facilitate the method of the present invention.

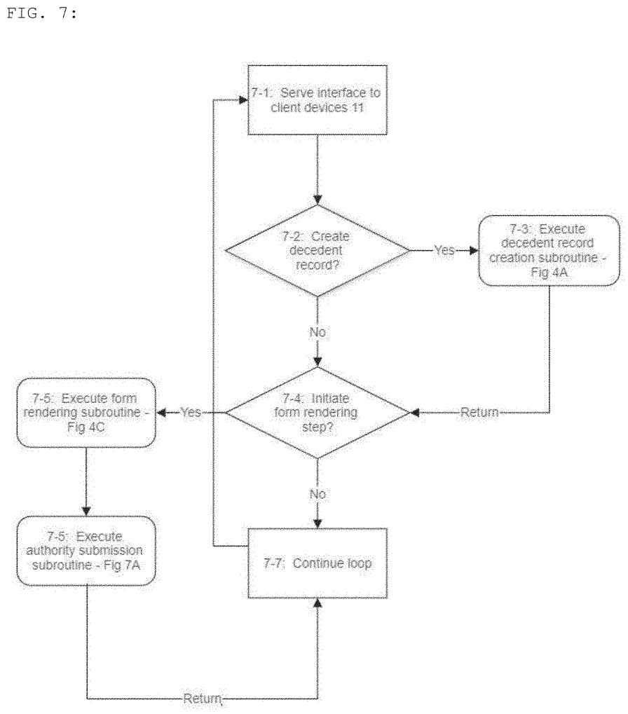

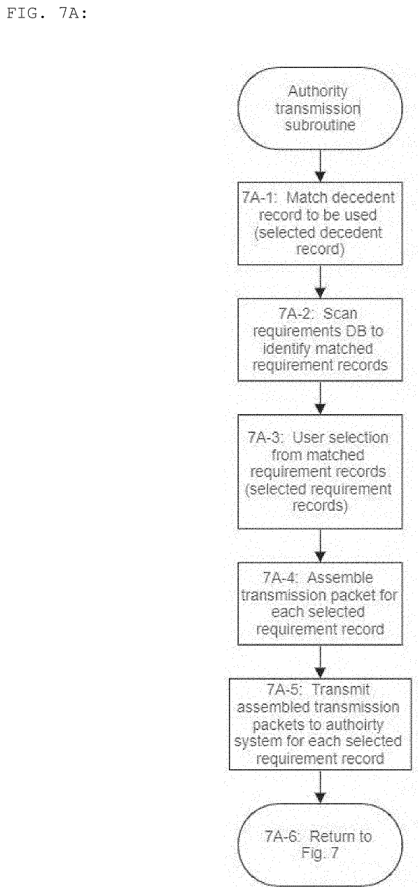

Referring next to FIG. 7 there is shown a flowchart for an alternate embodiment of the method of the present invention which addresses not only the rendering of forms as might be desired by user in the form rendering step but also addresses the ability of the system and the method of the present invention to facilitate the transfer of required information automatically selected authority systems. The method would be practised by a server and software configuration similar to that demonstrated in FIGS. 5 and 6 above. The difference between the system and the method of this Figure and the method shown in FIG. 4 is the inclusion of at least one authority system 12 in operative communication with the server 2. The authority systems 12 could comprise vendor computer systems, government computer systems or any other type of the system for information management of parties engaged with individuals who might become decedents and whose account records etc. might need to be updated upon their death. The authority systems 12 as contemplated would not be user facing in any way and in fact simply communicate with the server 2 apparently or behind-the-scenes. There would be authority records 40 corresponding to each authority system 12 which included in their most basic embodiment necessary authentication credentials to permit the server 2 to open a transmission session with the authority system 12 upon request, to transmit data in an approved packet format or completed rendered forms to the authority system 12 for filing. The authority records 40 could also include other information is acquired so take this.

The software component 4 and the remainder of the server will, as shown in the present embodiment, use a listener to detect a request from a client device 11 to initiate a session to create a decedent record 30 within a decedent database 7. Creation of a decedent record 30 would be the first user step to be taken by a user, via their client device 11, to engage with the system and to participate in the self-service estate administration assistance method of the present invention. The listener for initiation at this step is shown at step 7-2. If the listener step 7-2 is triggered i.e. a user by their client device 11 initiates with the server 2 a request to create a decedent record, the execution of the decedent record creation subroutine of FIG. 4A is shown in step 7-3. In the decedent record creation subroutine demonstrated in one embodiment of FIG. 4A the first step would be for the server 2 to serve a data entry interface to the client device 11 initiating request—this would typically be a data entry form or triggering a multipage data entry interview in which the desired information could be entered and captured.

The most important data token captured in respect of a decedent in addition to their basic identification information is their residential jurisdiction, the capture of which is shown at step 4A-2. The residential jurisdiction filter value which would be entered in respect of the decedent for storage to the decedent record to be created would be selected from a standardized system-level list of jurisdictions.

In addition to the capture of the residential jurisdictional filter value in respect of the decedent, the Figure also shows the capture of other decedent identification information and other decedent data values at 4A-3. As will be understood from the remainder of the specification, decedent data values which are entered in respect of a particular decedent for storage to a decedent record might include basic information and informational values for use in the rendering of particular forms in respect of the decedent in question, and those fields might also be usable in parallel or in isolation as nonjurisdictional filter values to aid the further limiting the selections of form records or requirement records in accordance with the remainder of the method.

Following the completion of the interview and/or the capture of various information in respect of a decedent for the creation of a decedent record, the captured decedent data and residential jurisdictional filter value will be transmitted to the server 2 from the client device, shown at 4A-4. On receipt of such a data transmission at the server, the software 4 would facilitate the creation of decedent record 30 in the decedent database 7 containing that information, shown at Step 4A-5. Control is then returned to the primary method of FIG. 7.

Either following the return of control to this primary flow and Figure after the execution of the decedent record creation subroutine, or if the no leg of the Step 7-2 listener is followed, the method executed by the software component for the server 2 will next comprise another logic test shown at step 7-4, namely to detect whether or not the user client device 11 having initiated a immediately preceding decedent record creation, or another client device 11 having passed over the decedent record creation step, has requested the initiation of a form rendering step by the server 2. Effectively, if a user by their client device 11 wishes to execute the deliverable of assembled jurisdictionally filtered forms or the transmission of formatted decedent data values to authority systems in accordance with the remainder of the present invention, the yes leg of this listener would be followed and the form rendering subroutine of FIG. 4B would be triggered as shown at step 7-5.

Referring to FIG. 4B, steps in a demonstrative example of an embodiment of a form rendering subroutine are shown. The server 2 and the software 4 would first in conjunction with information received from a client device 11 determine the selected decedent record 30 from the decedent database 7 which is necessary for the execution of this rendering subroutine. The rendering subroutine of this Figure might be conducted as a flow-through step immediately following the creation of a decedent record in accordance with the subroutine of FIG. 4 or in other embodiments of the method of the present invention, a user might return to the system via their client device 11 in communication with the server 2 to initiate a form rendering step or subroutine at some point in time following the creation of a decedent record 30. Either approach is contemplated within the scope of the present invention. Where the form rendering subroutine was committed immediately following the creation of the decedent record, necessary identifying information to match a decedent record, or the selected decedent record 30 itself might still be stored in the memory of the server 2 alternatively, matching the decedent record 30 to be used might entail at this step 4B-1 capturing identifying information and/or a security credential from the user device 11 in question to match the decedent record 30 in question and permits selection and use.

Following the determination of the selected decedent record 30, the next step in the subroutine shown at 4B-2 is the scanning of the form database 6 to identify any matched form records 20 which might in the initial cursory scan applied to the decedent in question. Matched form records 20 would be any form records 20 in which the jurisdictional filter value 22 stored in the form record 20 matched the jurisdictional filter value 33 stored in the selected decedent record 30. In certain cases the form record 20 in question might also include nonjurisdictional filter values 23 which would be compared against other decedent data values 34 stored within the selected decedent record 30.

Following the application of the jurisdictional and nonjurisdictional filter values of the form records 20 in the form database 6 to the decedent data stored within the selected decedent record 30, a subset of form records 20, being matched form records, would be identified.

Following the completion of the selection of the matched form records 20, the next step in the subroutine shown would be the serving of a user selection interface to the client device 11 of the in which the details of the matched form records 20 would be displayed. For example it might be determined that there were five matching form records that met the filter criteria for a particular decedent and decedent record. The titles or other information of those five records could be presented in a selection menu to the user by their client device 11 such that they could select some or all of those forms to be rendered. Any forms that were selected to be rendered would comprise the selected form records. This user selection step is shown at step 4B-3.

The form rendering subroutine would then render all of the forms corresponding to the selected form records identified in step 4B-3. Form rendering is shown at step 4B-4.

Finally, the rendered forms would be transmitted or otherwise made available to the client device and 11, shown at step 4B-5.

Following the completion of this form rendering subroutine, the authority transmission subroutine of FIG. 7A would be called and executed in this embodiment. This would effectively comprise offering to the user by their client device and will to optionally make one or more transmissions of decedent data or rendered forms to certain authority systems of authorities, vendors and the like who were configured were set up to automatically accept these transmissions and negate the need for the user to even manually forward file that information with those authorities.

Referring to FIG. 7A, steps in a demonstrative example of an embodiment of an authority transmission subroutine are shown. Given the execution of the authority transmission subroutine following the form rendering 17, the server 2 of the software for would already have identified the selected decedent record 30 and maintain that in memory, for use in the authority transmission subroutine.

Following the determination of the selected decedent record 30, the next step in the subroutine shown at 7A-2 is the scanning of the requirements database 9 to identify any matched requirement records 50 which might in the initial cursory scan applied to the decedent in question. Matched requirement records 50 would be any requirement records 50 in which the jurisdictional filter value 52 stored in the requirement record 50 matched the jurisdictional filter value 33 stored in the selected decedent record 30. In certain cases the requirement record 50 in question might also include nonjurisdictional filter values 53 which would be compared against other decedent data values 34 stored within the selected decedent record 30. Following the application of the jurisdictional and nonjurisdictional filter values of the requirement records 50 in the requirement database 9 to the decedent data stored within the selected decedent record 30, a subset of requirement records 50, being matched requirement records 50, would be identified.

Following the completion of the selection of the matched requirement records 50, the next step in the subroutine shown would be the serving of a user selection interface to the client device 11 of the user in which the details of the matched requirement records 50 would be displayed. For example it might be determined that there were five matching requirement records that met the filter criteria for a particular decedent and decedent record. The titles or other information of those five records could be presented in a selection menu to the user by their client device 11 such that they could select some or all of those requirements to be transmitted/completed. Any requirements that were selected to be completed would comprise the selected form records. This user selection step is shown at step 7A-3.

The authority transmission subroutine would then assemble a transmission packet of decedent data or rendered forms based on the parameters stored for each selected requirement record, based upon the format or framework defined and stored within the selected requirement record 50 in question. Rendering of these transmission packets is shown at step 4B-4. Finally, the rendered transmission packets would be transmitted to the authority system 12 responding selected requirement record 50, by opening a transmission communication session between server 2 of the authority system 12 in question using the authentication particulars stored in the related linked authority record 40.

Following the completion of the authority transmission subroutine, control and pass back to the primary flow of FIG. 7.

### Timing of Creation of Decedent Records

Decedent records 30 could be created in the decedent database 7 as part of a single workflow, wherein the decedent record 30 was created at the same time or in the same flow of events as the conduct of a retrieval step resulting in the rendering of forms and/or the filing of information with authority systems, or in other embodiments of the method, the decedent record 30 could be created at a separate time than the execution of the retrieval step i.e. the decedent record 30 could be created and saved to the decedent database 7 at one time in association with the credentials of a user, and a user could then upon authentication of themselves to the system at a later time recall the decedent record 30 to edit or to continue with a retrieval step, or to execute one of multiple retrieval steps against the decedent record 30 at different times. The use of the system of the present invention in either a single workflow or to permit the interval storage of the decedent record 30 for subsequent recall and use are both contemplated within the scope of the present invention.

It will be apparent to those of skill in the art that by routine modification the present invention can be optimized for use in a wide range of conditions and application. It will also be obvious to those of skill in the art that there are various ways and designs with which to produce the apparatus and methods of the present invention. The illustrated embodiments are therefore not intended to limit the scope of the invention, but to provide examples of the apparatus and method to enable those of skill in the art to appreciate the inventive concept.

Those skilled in the art will recognize that many more modifications besides those already described are possible without departing from the inventive concepts herein. The inventive subject matter, therefore, is not to be restricted except in the scope of the appended claims. Moreover, in interpreting both the specification and the claims, all terms should be interpreted in the broadest possible manner consistent with the context. The terms “comprises” and “comprising” should be interpreted as referring to elements, components, or steps in a non-exclusive manner, indicating that the referenced elements, components, or steps may be present, or utilized, or combined with other elements, components, or steps not expressly referenced.

1. A method of providing self-service assistance to a user in documentary estate administration tasks, using a server comprising:
a. a processor and memory;
b. a network interface for communication with user client devices each having a user interface;
c. a estate administration software component for executing the steps of the method;
d. a form database containing form records each corresponding to a form for completion for a decedent and comprising at least the following values:
i. a jurisdictional filter value corresponding to the decedent's residential jurisdiction in respect of which the form is to be used, selected from a list of standardized jurisdictional values;
ii. any non-jurisdictional filter values corresponding to other decedent data which further limit the applicability of the corresponding form to a particular decedent;
iii. rendering data for the rendering of the form for display or download from the server to a client device; and
iv. field indicators, mapping any additional decedent data inputs required from a user or calculations required to render the form; and
e. a decedent database containing decedent records each corresponding to a decedent in respect of whom the system can assist in estate administration and comprising at least the following values:
i. identification of the decedent;
ii. residential jurisdiction of the decedent selected from the list of standardized jurisdictional values; and
iii. additional decedent data values corresponding to the decedent and their estate;
said method comprising, using the server and the estate administration software component:
a. creating a decedent record in respect of a decedent on receipt of a request to do from a user client device by:
a. serving a data entry interface to the user interface of the user client device in which the user can complete a user interview by entering captured decedent data values corresponding to at least:
i. identification of the decedent;
ii. the residential jurisdiction of the decedent selected from the list of standardized jurisdictional values; and
iii. any additional decedent data values corresponding to the decedent and their estate; and
b. on user completion of the interview, receiving transmitted the captured decedent data values from the user client device at the server and creating and storing a decedent record in the decedent database storing the captured decedent data;
b. in a form rendering step, rendering forms from the form database to a user client device in respect of a requested decedent when requested by:
a. conducting a matching step comprising:
i. capturing identifying information of the requested decedent from the user client device;
ii. matching the identifying information of the requested decedent to a decedent record in the decedent database, being the selected decedent record;
iii. scanning the form records stored within the form database to identify any matched form records in which:
1. the residential jurisdiction stored in the selected decedent record matches the jurisdictional filter value stored in the form record; and
2. any non-jurisdictional filter values stored in the form record are matched to decedent data values stored in the selected decedent record;
b. presenting the details of matched form records to the user interface of the user client device in a selection interface and permitting the user to select at least one of the matched form records for rendering, being selected form records; and
c. for each selected form record:
i. using the rendering data and field indicators stored in the selected form record along with the decedent data stored in the selected decedent record to render a completed version of the form corresponding to the selected form record adapted to the decedent data stored in the selected decedent record; and
ii. making the completed version of said form available to the user for use via the user interface of the user device;
wherein only applicable forms based upon the residential jurisdiction and any other non-jurisdictional filter values of a particular decedent will be offered or rendered by the system in respect of the decedent.

2. The method of claim 1 wherein the decedent in respect of whom a decedent record is created is deceased.

3. The method of claim 1 wherein the decedent in respect of whom a decedent record is created is a living individual, and the system is being used in estate preplanning.

4. The method of claim 1 wherein the completed version of a form is adapted in rendering to include or exclude sections thereof based on the contents of the selected decedent record.

5. The method of claim 1 wherein the non-jurisdictional filter values used to limit the selection of forms in respect of a particular decedent are selected from the group of: age, income, date of death, jurisdiction of birth, date of birth, residential address, cause of death, family status, marital status, vendor account number or status, government program registration or eligibility, or vendor subscription status.

6. The method of claim 1 wherein at least one field indicator in a form record includes details of a calculation to determine a calculated value based upon decedent data in the selected decedent record, and the rendering of the related form when the form record is a matched form record includes executing the necessary calculation for the calculated value for use in the rendered form.

7. The method of claim 1 wherein the estate administration software component is programmed to administer an adaptive interview, whereby the nature of the questions asked and the decedent data captured from the user is adapted based upon values entered by the user to alter the questions presented and asked and decedent data captured.

8. The method of claim 1 wherein:
a. the server further comprises:
i. an authority database containing at least one authority record corresponding to a network-connected authority system requiring data updates on death of a decedent, each authority record comprising at least any necessary authentication information to enable communication between the server and the authority system via the network connection; and
ii. a requirements database containing at least one requirement record corresponding to a form or decedent data to be filed with an authority system in respect of a decedent, each requirement record comprising at least:
1. a link to the authority record of the corresponding authority;
2. a jurisdictional filter value corresponding to the decedent's residential jurisdiction in respect of which the requirement record is to be activated, selected from the list of standardized jurisdictional values;
3. any non-jurisdictional filter values corresponding to other decedent data which further limit the activation of the requirement record in respect of a particular decedent; and
4. details of any required decedent data and format to be transmitted to the linked authority system on activation of the requirement record;
b. the method further comprises an authority filing step following the form rendering step comprising:
i. scanning the requirement records stored within the requirements database to identify any matched requirement records wherein:
1. the residential jurisdiction stored in the selected decedent record matches the jurisdictional filter value stored in the requirement record; and
2. any non-jurisdictional filter values stored in the requirement record are matched to decedent data values in the selected decedent record;
d. presenting the details of matched requirement records to the user interface of the user client device, from which the user can indicate a transmission selection for the matched requirement records selected for rendering, being selected requirement records; and
e. for each selected requirement record:
i. using the decedent data stored in the selected decedent record, assembling a filing packet of the required decedent data and format to be transmitted identified in the selected requirement record;
ii. opening a transmission session to the authority system identified in the linked authority record using the stored authentication information therefrom;
iii. transmitting the filing packet to the authority system within the transmission session; and
iv. closing the transmission session.

9. A server for use in the facilitation of a method of providing self-service assistance to a user in documentary estate administration tasks, said server comprising:
a. a processor and memory;
b. a network interface for communication with user client devices each having a user interface;
c. a estate administration software component for executing the steps of the method;
d. a form database containing form records each corresponding to a form for completion for a decedent and comprising at least the following values:
i. a jurisdictional filter value corresponding to the decedent's residential jurisdiction in respect of which the form is to be used, selected from a list of standardized jurisdictional values;
ii. any non-jurisdictional filter values corresponding to other decedent data which further limit the applicability of the corresponding form to a particular decedent;
iii. rendering data for the rendering of the form for display or download from the server to a client device; and
iv. field indicators, mapping any additional decedent data inputs required from a user or calculations required to render the form; and
e. a decedent database containing decedent records each corresponding to a decedent in respect of whom the system can assist in estate administration and comprising at least the following values:
i. identification of the decedent;
ii. residential jurisdiction of the decedent selected from the list of standardized jurisdictional values; and
iii. additional decedent data values corresponding to the decedent and their estate;
wherein the server can facilitate the method using the estate administration software component by:
a. creating a decedent record in respect of a decedent on receipt of a request to do from a user client device by:
a. serving a data entry interface to the user interface of the user client device in which the user can complete a user interview by entering captured decedent data values corresponding to at least:
i. identification of the decedent;
ii. the residential jurisdiction of the decedent selected from the list of standardized jurisdictional values; and
iii. any additional decedent data values corresponding to the decedent and their estate; and
b. on user completion of the interview, receiving transmitted the captured decedent data values from the user client device at the server and creating and storing a decedent record in the decedent database storing the captured decedent data;
b. in a form rendering step, rendering forms from the form database to a user client device in respect of a requested decedent on receipt of a request for a user client device to do so by:
a. conducting a matching step comprising:
i. capturing identifying information of the requested decedent from the user client device;
ii. matching the identifying information of the requested decedent to a decedent record in the decedent database, being the selected decedent record;
iii. scanning the form records stored within the form database to identify any matched form records in which:
1. the residential jurisdiction stored in the selected decedent record matches the jurisdictional filter value stored in the form record; and
2. any non-jurisdictional filter values stored in the form record are matched to decedent data values stored in the selected decedent record;
b. presenting the details of matched form records to the user interface of the user client device in a selection interface and permitting the user to select at least one of the matched form records for rendering, being selected form records; and
c. for each selected form record:
i. using the rendering data and field indicators stored in the selected form record along with the decedent data stored in the selected decedent record to render a completed version of the form corresponding to the selected form record adapted to the decedent data stored in the selected decedent record; and
ii. making the completed version of said form available to the user for use via the user interface of the user device;
wherein only applicable forms based upon the residential jurisdiction and any other non-jurisdictional filter values of a particular decedent will be offered or rendered by the system in respect of the decedent.

10. The server of claim 9 wherein the decedent in respect of whom a decedent record is created is deceased.

11. The server of claim 9 wherein the decedent in respect of whom a decedent record is created is a living individual, and the system is being used in estate preplanning.

12. The server of claim 9 wherein the method conducted is the method of any one of claims 1 to 7.

13. The server of claim 9 further comprising:
a. an authority database containing at least one authority record corresponding to a network-connected authority system requiring data updates on death of a decedent, each authority record comprising at least any necessary authentication information to enable communication between the server and the authority system via the network connection; and
b. a requirements database containing at least one requirement record corresponding to a form or decedent data to be filed with an authority system in respect of a decedent, each requirement record comprising at least:
i. a link to the authority record of the corresponding authority;
ii. a jurisdictional filter value corresponding to the decedent's residential jurisdiction in respect of which the requirement record is to be activated, selected from the list of standardized jurisdictional values;
iii. any non-jurisdictional filter values corresponding to other decedent data which further limit the activation of the requirement record in respect of a particular decedent; and
iv. details of any required decedent data and format to be transmitted to the linked authority system on activation of the requirement record;
and wherein the method further comprises an authority filing step following the form rendering step comprising:
a. scanning the requirement records stored within the requirements database to identify any matched requirement records, matched requirement records being any requirement records in which:
i. the residential jurisdiction stored in the selected decedent record matches the jurisdictional filter value stored in the requirement record; and
ii. any non-jurisdictional filter values stored in the requirement record are matched to decedent data values in the selected decedent record;
b. presenting the details of matched requirement records to the user interface of the user client device, from which the user can indicate a transmission selection for the matched requirement records selected for rendering, being selected requirement records; and
c. for each selected requirement record:
a. using the decedent data stored in the selected decedent record, assembling a filing packet of the required decedent data and format to be transmitted identified in the selected requirement record;
b. opening a transmission session to the authority system identified in the linked authority record using the stored authentication information therefrom; and
c. transmitting the filing packet to the authority system within the transmission session; and
d. closing the transmission session.
